(19) United States
(12) Patent Application Publication
(10) Pub. No.: US 2010/0096331 A1
(43) Pub. Date: Apr. 22, 2010

(54) Filtration of a hydrocarbon from a fluid

(76) Inventor: Craig A. Mason, Corona, CA (US)

Correspondence Address: THE MILLER LAW OFFICES, PLC, 801 BRICKELL AVE, SUITE 900, MIAMI, FL, 33131, US

(21) Appl. No.: 12/582,684

(22) Filed: Oct. 20, 2009

Related U.S. Application Data
(60) Provisional application No. 61/107,153, filed on Oct. 21, 2008.

(51) Int. Cl. B01D 15/24; B01D 15/08

(52) U.S. Cl. 210/665; 210/258; 210/257.1

(57) ABSTRACT

An apparatus for, method of, and system for treatment of industrial waste water and/or marine vessel bilge waste water before discharge into rivers, lakes, streams and oceans, said waste water having hydrocarbon and non-hydrocarbon liquid chemical emulsions containing organics and fine suspended particulate matter, said treatment utilizing a hydrocarbon sorbing media together with filter structural elements to first coalesce then bifurcate the hydrocarbon elements from the non-hydrocarbon elements in the emulsion, then the remaining liquid entering the second stage of filtration wherein a positively charged nano-fiber material removes the remaining organics and other fine particulate in the submicron sized range, providing a highly clarified and oil free effluent at high flow rates and with substantially reduced filter system maintenance. The apparatus, method and system may further contain a third stage utilizing another layer of hydrocarbon sorbing materials. It may be combined into a larger oily water separation system.

### CROSS REFERENCE TO RELATED APPLICATIONS

This non-provisional application claims priority from applicant's U.S. provisional application No. 61/107,153 filed on Oct. 21, 2008.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

1. Field of the Invention

This invention relates to an apparatus for, method of, and system for environmentally acceptable treatment of industrial waste water and/or marine vessel bilge waste water before discharge into rivers, lakes, streams and oceans, said waste water comprising hydrocarbon and non-hydrocarbon liquid chemical emulsions comprising organics and fine suspended particulate matter, said treatment utilizing a hydrocarbon sorbing media (such as polypropylene fibers) together with filter structural elements to first coalesce then bifurcate the hydrocarbon elements from the non-hydrocarbon elements in the emulsion, then the remaining liquid entering the second stage of filtration wherein a positively charged nano-fiber material removes the remaining organics and other fine particulate in the submicron sized range, providing a highly clarified and oil free effluent at high flow rates and with substantially reduced filter system maintenance. The apparatus, method and system may further contain a third stage comprising another layer of hydrocarbon sorbing materials. Further, the aformentioned apparatus, method and system can be combined into a larger oily water separation system comprising electronic oil content monitors and piping to allow the continuous discharge of the separated contaminants to separate storage tanks. The apparatus, method and system of the present invention results in an substantially reduced maintenance means for substantially removing hydrocarbon and organic non-hydrocarbon containing contaminants from industrial waste water and marine vessel bilge water before discharge into rivers, lakes, streams and oceans.

2. Description of Related Art

Industrial facilities such as chemical plants, utility power plants, hospital power plants, corporate and collegiate campus facilities, oil and chemical refineries, and vehicle parking facilities, are coming under increasing scrutiny as sources of hydrocarbon contamination and other chemical and/or pollutant contamination resulting in water having and oil sheen with other small particulate emulsions, such as vehicle and power plant combustion by-products being discharged into streams and ground water. The difficulty is not just handling the hydrocarbons and non-hydrocarbon particulate emulsions, but separating it efficiently and economically from a substantial flow of water. For some time there has been a need to find a way to make a better polishing filter to remove oil and hydrocarbons, both dispersed and emulsified, from flowing water. Current filters on the market are not able to break a chemical/surfactant emulsion, particularly with a single cartridge, they tend to blind or plug quickly, or begin to pass high levels of oil/hydrocarbons after only a small amount of oil is introduced to the cartridges. Turbidity and discoloring of the water from organics and fine suspended particulate matter is also not solved with current filters and said matter causes false positives on electronic pollution monitoring equipment. U.S. Pat. No. 6,838,005 and U.S. Pat. No. 7,390,343 (the “Tepper” patents), are directed, to the purification and sterilization of drinking water, biological, medical and pharmaceutical fluids, and as a collector/concentrator for detection and assay of mirobes and viruses. These patents were not directed to removing the combination of large amounts of hydrocarbons combined with non-hydrocarbon industrial organics and fine particulate from combustion products from a flowing stream of industrial waste water and marine vessel bilges from water intrusion to said facilities. The Tepper prior art quickly clogs, plugs and fails when subjected to the combined aformentioned industrial contaminants. Further, U.S. Pat. No. 6,485,639, U.S. Pat. No. 6,503,390 and U.S. Pat. No. 6,841,077 (the “Gannon” patents), are directed, to filtration and separation devices and methods wherein a combination of polymers are used to dissolve, tackify and then actually plug or stop-up, when subjected to substantial hydrocarbon contamination of a water stream, thereby necessarily ceasing all flow of water and requiring a change out of the entire filter. The Gannon patents do not address the problem of other non-hydrocarbon organics, combustion products, fine particulate, turbidity and bacteria that may co-exist with said hydrocarbon contaminants. A new filter design is needed to be able to remove both substantial quantities of hydrocarbons and fine particulate organic and combustion products from a continous substantial flow of water, such as would be needed to pump out or drain an area from rain and other water intrusion in power plant facilities, parking lots and marine vessel bilges. Thus, it would be desirable to develop a filter apparatus, method and system, such that the apparatus and system does not easily clog or plug, while being injected with a large amount of industrially contaminated waste water comprising both large quantities of various hydrocarbons and non-hydrocarbon containing organic and particulate emulsions. Many of the emulsions and fine suspended particulate in industrial waste water and marine vessel bilge water have a negative charge. What was needed is an apparatus, method and system to solve the problem of bacteria, vehicle and power plant combustion products, and other organics, combustion product particulates and hydrocarbon contaminants, all together, in the industrial waste water and marine vessel bilge water that cause false positive readings on the new electronic oil content monitors.

Bearing in mind the problems and deficiencies of the prior art, it is therefore an object of the present invention to solve the aformentioned problems in the prior art by providing an apparatus for, method of, and system for treatment of hydrocarbon and non-hydrocarbon containing emulsified contaminated industrial waste water contaminated wherein the contaminated water is rendered substantially hydrocarbon, organics and fine particulate free and clear, for discharge into a river, lake, stream, ground water or ocean.

Other objects and advantages of the invention will in part be obvious and will in part be apparent from the specification.

### BRIEF SUMMARY OF THE INVENTION

The above and other objects and advantages, which will be apparent to one of skill in the art, are achieved in the present invention which is directed to, an apparatus for, method of, and system for environmentally acceptable treatment of industrial waste water and/or marine vessel bilge waste water before discharge into rivers, lakes, streams and oceans, said waste water comprising hydrocarbon and non-hydrocarbon liquid chemical emulsions comprising organics and fine suspended particulate matter, said treatment utilizing a hydrocarbon sorbing media (such as polypropylene fibers) together with filter structural elements to first coalesce then bifurcate the hydrocarbon elements from the non-hydrocarbon elements in the emulsion, then the remaining liquid entering the second stage of filtration wherein a positively charged nano-fiber material removes the remaining organics and other fine particulate in the submicron sized range, providing a highly clarified and oil free effluent at high flow rates and with substantially reduced filter system maintenance. The apparatus, method and system may further contain a third stage comprising another layer of hydrocarbon sorbing materials. Further, the aformentioned apparatus, method and system can be combined into a larger oily water separation system comprising electronic oil content monitors and piping to allow the continuous discharge of the separated contaminants to separate storage tanks. The apparatus, method and system of the present invention results in an substantially reduced maintenance means for substantially removing hydrocarbon and organic non-hydrocarbon containing contaminants from industrial waste water and marine vessel bilge water, without clogging or plugging, before discharge into rivers, lakes, streams and oceans.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

In the drawings:

FIG. 1 is a cross-sectional view of a preferred embodiment of an apparatus of the present invention.

FIG. 2 is a plan view the preferred embodiment of an apparatus of the present invention as shown in FIG. 1.

### DETAILED DESCRIPTION OF THE EMBODIMENTS

Detailed descriptions of the preferred embodiment are provided herein. It is to be understood, however, that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure or manner.

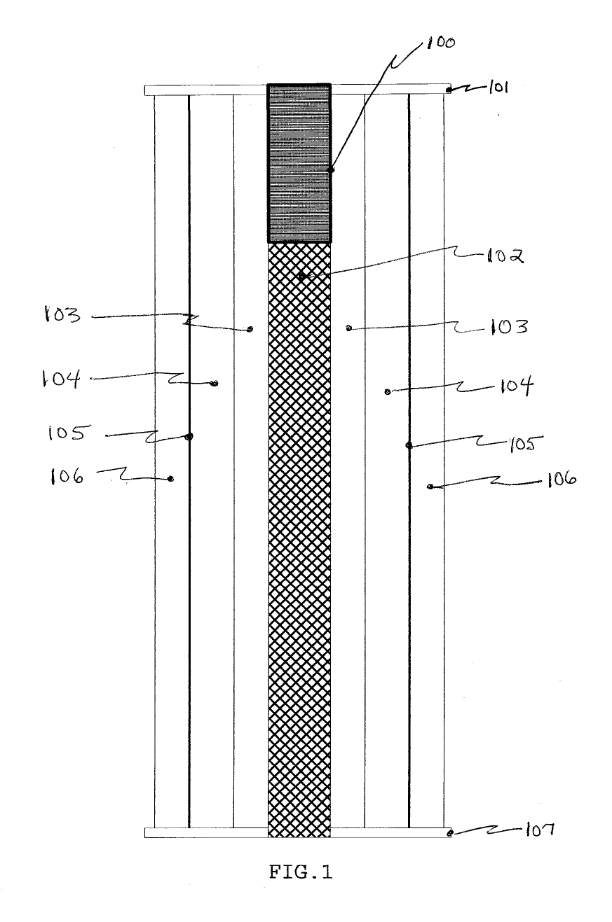

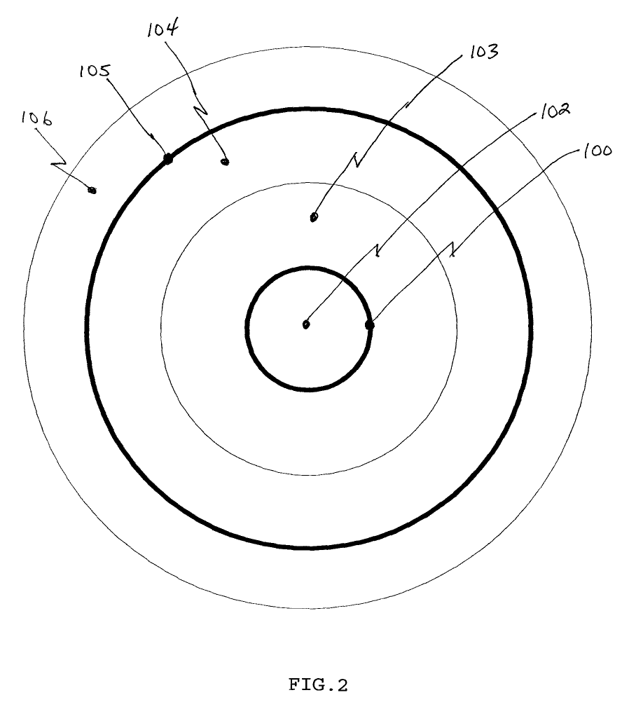

In describing the preferred embodiment of the present invention, reference will be made herein to FIG. 1 and FIG. 2 of the drawings in which like numerals refer to like features of the invention. Features of the invention are not necessarily shown to scale in the drawings.

The present invention provides an apparatus for, method of, and system for environmentally acceptable treatment of industrial waste water and/or marine vessel bilge waste water before discharge into rivers, lakes, streams and oceans, said waste water comprising hydrocarbon and non-hydrocarbon liquid chemical emulsions comprising organics and fine suspended particulate matter, said treatment utilizing a hydrocarbon sorbing media (such as polypropylene fibers) together with filter structural elements to first coalesce then bifurcate the hydrocarbon elements from the non-hydrocarbon elements in the emulsion, then the remaining liquid entering the second stage of filtration wherein a positively charged nano-fiber material removes the remaining organics and other fine particulate in the submicron sized range, providing a highly clarified and oil free effluent at high water flow rates, without clogging or plugging, and with substantially reduced filter system maintenance. The apparatus, method and system may further contain a third stage comprising another layer of hydrocarbon sorbing materials. Further, the aformentioned apparatus, method and system can be combined into a larger oily water separation system comprising electronic oil content monitors and piping to allow the continuous discharge of the separated contaminants to separate storage tanks. The apparatus, method and system of the present invention results in an substantially reduced maintenance means for substantially removing hydrocarbon and organic non-hydrocarbon containing contaminants from industrial waste water and marine vessel bilge water before discharge into rivers, lakes, streams and oceans.

In FIG. 1 and FIG. 2 is disclosed an embodiment of the present invention which is placed on the discharge of a pumping system or in the drainage flow stream of a gravity fed water drain off system. The pump takes suction from contaminated industrial waste water or contaminated marine vessel bilge water, said waste water having both hydrocarbon and non-hydrocarbon organic and particulate contaminants. The embodiment is shown in a cylindrical geometry, but the invention is not limited thereby. As shown, said contaminated industrial waste water would enter from the discharge of the aformentioned pumping system on the outside periphery of FIG.'s 1 and 2 into an oil sorbent layer (106) which may be 3 to 5 micron polypropylene fiber material. The next adjacent interior material is the pleated layers of positively charged nano-fiber material (104). When the emulsion enters the polypropylene fibers and then the positively charged and pleated sheets of nano-fiber material at the interface (105), the hydrocarbons separate from the emulsion and are then sorbed, and due to density differences as well as electrical charge differences, the bulk of the hydrocarbons rise up vertically to the top of the cylindrical housing shown. Any remaining hydrocarbons are sorbed and directed vertically up by the interior layer of hydrocarbon sorbing material (such as 1 micron polypropylene fiber) (103). Said hydrocarbons are structurally and mechanically trapped from breaking through the top section of the cylindrical filter and entering the clean discharge by the cylindrical baffle (100) located in the top section of the apparatus together with the top cover (101). The hydrocarbon sorbent material (106) and (103) assists in retention and direction of the hydrocarbon so as to inhibit mixing of the hydrocarbon with the clean water discharge flowing into and vertically up the filter core support tube (102). The top cover plate (101) together with the cylindrical baffle (100) act to direct the oil discharge for retention or flow out to a separate storage tank, thereby ensuring clean discharge out of the top of the tube (102). The other organics and fine particulate, including such contaminants as vehicle and power plant combustion products and bacteria, will be removed by the positively charged nano-fiber material layer (104), said material comprising aluminum oxide and/or magnesium oxide. It should be noted that another embodiment of the invention may eliminate the interior second layer of hydrocarbon sorbent material (103) entirely, and yet still function to remove the aforementioned combination of industrial pollutants and contaminants.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

In so far as the description above and the accompanying drawings disclose any additional subject matter that is not within the scope of the claims below, the inventions are not dedicated to the public and the right to file one or more applications to claim such additional inventions is reserved.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

What is claimed is:

1. An apparatus for the filtering of waste water from the discharge of a waste water pump said waste water having both hydrocarbon and non-hydrocarbon organic and particulate contaminants, comprising:
a first filtering stage utilizing a hydrocarbon sorbing media together with filter structural elements to first coalesce then bifurcate the hydrocarbon elements from the non-hydrocarbon elements in the emulsion,
a second filtering stage in which the remaining liquid enters and wherein a positively charged nano-fiber material removes the remaining organics and other fine particulate in the submicron sized range,
thereby providing a highly clarified and oil free effluent at high water flow rates, without clogging or plugging, and
with substantially reduced filter system maintenance.

2. The apparatus as in claim 1 further comprising a third filtering stage having another layer of hydrocarbon sorbing materials.

3. The apparatus as in claim 1 being combined into a larger oily water separation system said system comprising electronic oil content monitors and piping to allow the continuous discharge of the separated contaminants to separate storage tanks.

4. The apparatus as in claim 2 being combined into a larger oily water separation system said system comprising electronic oil content monitors and piping to allow the continuous discharge of the separated contaminants to separate storage tanks.

5. The apparatus as in claim 1 wherein the hydrocarbon sorbent media is 3 to 5 micron polypropylene fiber material.

6. A method for the filtering of waste water from the discharge of a waste water pump said waste water having both hydrocarbon and non-hydrocarbon organic and particulate contaminants, comprising:
having a first filtering stage utilizing a hydrocarbon sorbing media together with filter structural elements to first coalesce then bifurcate the hydrocarbon elements from the non-hydrocarbon elements in the emulsion,
having a second filtering stage in which the remaining liquid enters and wherein a positively charged nano-fiber material removes the remaining organics and other fine particulate in the submicron sized range, thereby providing a highly clarified and oil free effluent at high water flow rates, without clogging or plugging, and
with substantially reduced filter system maintenance.

7. The method as in claim 6 further comprising having a third filtering stage with another layer of hydrocarbon sorbing materials.

8. The method as in claim 6 combining into a larger oily water separation system said system comprising electronic oil content monitors and piping to allow the continuous discharge of the separated contaminants to separate storage tanks.

9. The method as in claim 7 combining into a larger oily water separation system said system comprising electronic oil content monitors and piping to allow the continuous discharge of the separated contaminants to separate storage tanks.

10. The method as in claim 6 using hydrocarbon sorbent media which is 3 to 5 micron polypropylene fiber material.

11. A system for the filtering of waste water from the discharge of a waste water pump said waste water having both hydrocarbon and non-hydrocarbon organic and particulate contaminants, comprising:
having a first filtering stage utilizing a hydrocarbon sorbing media together with filter structural elements to first coalesce then bifurcate the hydrocarbon elements from the non-hydrocarbon elements in the emulsion,
having a second filtering stage in which the remaining liquid enters and wherein a positively charged nano-fiber material removes the remaining organics and other fine particulate in the submicron sized range,
thereby providing a highly clarified and oil free effluent at high water flow rates, without clogging or plugging, and
with substantially reduced filter system maintenance.

12. The system as in claim 11 further comprising having a third filtering stage with another layer of hydrocarbon sorbing materials.

13. The system as in claim 11 combining into a larger oily water separation system said system comprising electronic oil content monitors and piping to allow the continuous discharge of the separated contaminants to separate storage tanks.

14. The system as in claim 12 combining into a larger oily water separation system said system comprising electronic oil content monitors and piping to allow the continuous discharge of the separated contaminants to separate storage tanks.

15. The system as in claim 11 using hydrocarbon sorbent media which is 3 to 5 micron polypropylene fiber material.
